(19) United States
(12) Patent Application Publication
(10) Pub. No.: US 2006/0188226 A1
(43) Pub. Date: Aug. 24, 2006

(54) Method and apparatus for setting marks on content recorded on a recording medium and conducting operations in accordance with the marks

(76) Inventor: Sung Wan Park, Suwon-si (KR)

Correspondence Address: HARNESS, DICKEY & PIERCE, P.L.C., P.O. BOX 8910, RESTON, VA, 20195, US

(21) Appl. No.: 11/342,869

(22) Filed: Jan. 31, 2006

(30) Foreign Application Priority Data
Jan. 31, 2005 (KR) 10-2005-0008503

(51) Int. Cl. H04N 7/52

(52) U.S. Cl. 386/95

(57) ABSTRACT

The present invention relates to a method and apparatus for setting marks on the content recorded on a data recording medium and carrying out operations in accordance with the marks. The apparatus according to the present invention includes a playback unit and an advanced content processor. The playback unit reads the recorded content and produces decoded content by driving the recording medium. The advanced content processor interprets additional navigation data designated for interactive playback of the content; based on more than one mark information contained in the additional navigation data, the advanced content processor sets the corresponding position within the content according to individual mark information at the playback unit. When the detection of a set position is notified from the playback unit in the course of playback of the content, the advanced content processor carries out operations specified by the additional navigation data with respect to the mark information associated with the detected position.

### PRIORITY INFORMATION

This application claims priority under 35 U.S.C. §119 on Korean Patent Application No. 10-2005-0008503, filed on Jan. 31, 2005, the entire contents of which are hereby incorporated by reference.

### BACKGROUND

1. Field of the Invention

This document relates to a method and an apparatus for setting particular positions or intervals of content of an interactive DVD and for controlling playback of the content according to the set positions or intervals.

2. Description of the Related Art

A storage medium containing a large amount of digital data such as DVD has a very high recording capacity. DVD is a high capacity recording medium and provides a large space for data storage, capable of recording high quality video data as well as high quality audio data extending over many hours.

DVD provides two recording areas: one is designated for recording actual data (namely, video or A/V data), whereas the other one is designated to record control or navigation data needed for playback control of the recorded actual data.

When DVD is inserted and loaded successfully into a DVD playback apparatus, the navigation data are first read out and stored into memory within the apparatus; subsequently, with reference to the commands or control information contained in the navigation data, the actual data (A/V data) are reproduced. Accordingly, a user, by using the DVD playback apparatus, can watch high quality video recorded in a DVD.

Recently, an interactive or enhanced navigation system has been proposed (namely, I-DVD or ENAV (Enhanced Navigation)). An interactive content disc such as I-DVD or ENAV disc can contain control, navigation, or additional A/V data in the form of HTML (Hyper-Text Markup Language) or XML (Extensible Markup Language) file. The control or navigation data serve for an interactive playback apparatus (namely, I-DVD or ENAV disc player) to reproduce main A/V data recorded in the interactive disc along with additional auxiliary data such as scenes or actors' narratives.

The aforementioned navigation data is called as enhanced or additional navigation data; the additional (enhanced) navigation data, together with main A/V data, can be recorded in a content disc in the form of playback-only data or provided from a remote server through a network.

On the one hand, some particular intervals of A/V data recorded in the interactive disc may contain scenes that must not be presented in some countries because of religious or racial issues. Considering this point, different versions of A/V content according to individual nations can be produced and recorded into the disc.

However, the aforementioned method of recording A/V content differently is a very annoying task to producers; thus, it is more preferable to record the same A/V data for all discs and as for the playback of the A/V data in question, employ enhanced navigation data to control the playback of the particular intervals. It is because additional navigation data are programmed by mark-up languages as mentioned previously; besides, they can be provided and renewed at a later time as needed through a network.

Therefore, a means for setting particular positions or intervals of A/V data recorded in the disc by utilizing additional navigation data is needed.

### SUMMARY OF THE INVENTION

The present invention is directed to provide a means for an interactive disc player to recognize positions marked on the A/V content by making use of additional navigation data in order to carry out special operations at particular positions or intervals of A/V content.

The playback apparatus according to one embodiment of the present invention includes a playback unit and an advanced content processor. The playback unit reads the recorded content by driving the recording medium and decodes the read content. The advanced content processor interprets additional navigation data designated for interactive playback of the content and sets corresponding positions within the content according to individual mark information to the playback unit based on one or more mark information contained in the additional navigation data. When detection of a set position is notified from the playback unit in the course of playback of the content, the advanced content processor carries out operations specified by the navigation data with respect to mark information associated with the detected position.

The apparatus according to another embodiment of the present invention includes a control unit controlling a playback unit which reads the recorded content by driving a recording medium and decodes the read content; and an advanced content processor which interprets additional navigation data designated for interactive playback of the content and, based on one or more mark information contained in the additional navigation data, sets corresponding positions within the content according to individual mark information to the playback unit. When detection of the set position is notified from the playback unit in the course of playback of the content, the control unit changes displayed playback information, for example, chapter number of the content.

In one embodiment of the present invention, the additional navigation data is recorded in the recording medium together with the content.

In another embodiment of the present invention, the additional navigation data is provided from a remote server connected to the playback apparatus through a communications network.

Also, in one embodiment of the present invention, the mark information includes the position information of a mark and identification information of the mark such as mark name.

In one embodiment of the present invention, the position information of the mark is expressed in terms of presentation time of the content.

In another embodiment of the present invention, the position information of the mark is expressed by the number in terms of a navigation unit which divides and partitions the content.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 illustrates the structure of the interactive disc player according to the present invention;

FIGS. 2a and 2b illustrate exemplary embodiments of setting marks according to the present invention and programming to specify operations according to the marks;

FIG. 3 illustrates marks according to the present invention and API commands/responses exchanged accordingly; and

FIG. 4 illustrates a displayed screen waiting for the user input with respect to a particular mark according to one embodiment of the present invention.

### DETAILED DESCRIPTION OF THE EMBODIMENTS

In order that the invention may be fully understood, preferred embodiments thereof will now be described with reference to the accompanying drawings.

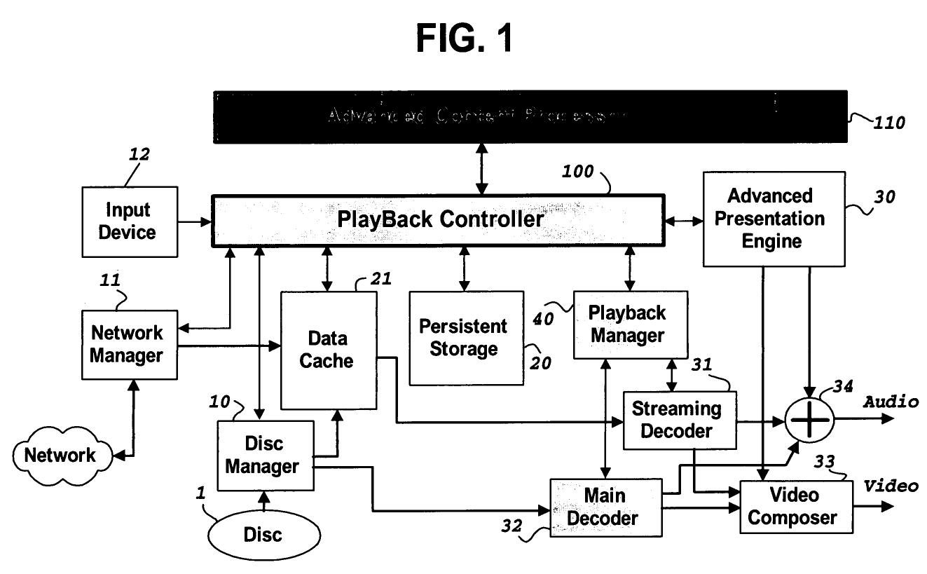

FIG. 1 illustrates the structure of an interactive disc player according to the present invention. The player shown in FIG. 1 comprises disc manager 10 which drives a disc 1 and reads the data recorded therein; network manager 11 which is connected to the Internet or a home network and exchanges data with the network; input device 12 which manages inputs from the user or external devices; persistent storage 20 where the data required for playback are stored on loading a disc 1 and the stored data are retained until withdrawal of the disc; data cache 21 where an amount of data as needed at each instant of playback are stored or renewed; main decoder 32 which decodes main content data reproduced from the disc 1 and produces video and audio signals; streaming decoder 31 which decodes A/V streaming data provided from an external network; advanced presentation engine 30 which produces presentation outputs by using graphics data, sound effects, and/or enhanced text data constituting additional content; video composer 33 which composes input video/graphics signals into a single image screen; audio mixer 34 which combines input audio signals and produces synthesized audio signals; playback manager 40 which manages operations for A/V presentation; advanced content processor 110 which interprets additional navigation files and carries out operations according thereto; and playback controller 100 which controls the interactive playback of content by exchanging data with structuring elements and transmitting control data to associated structuring elements.

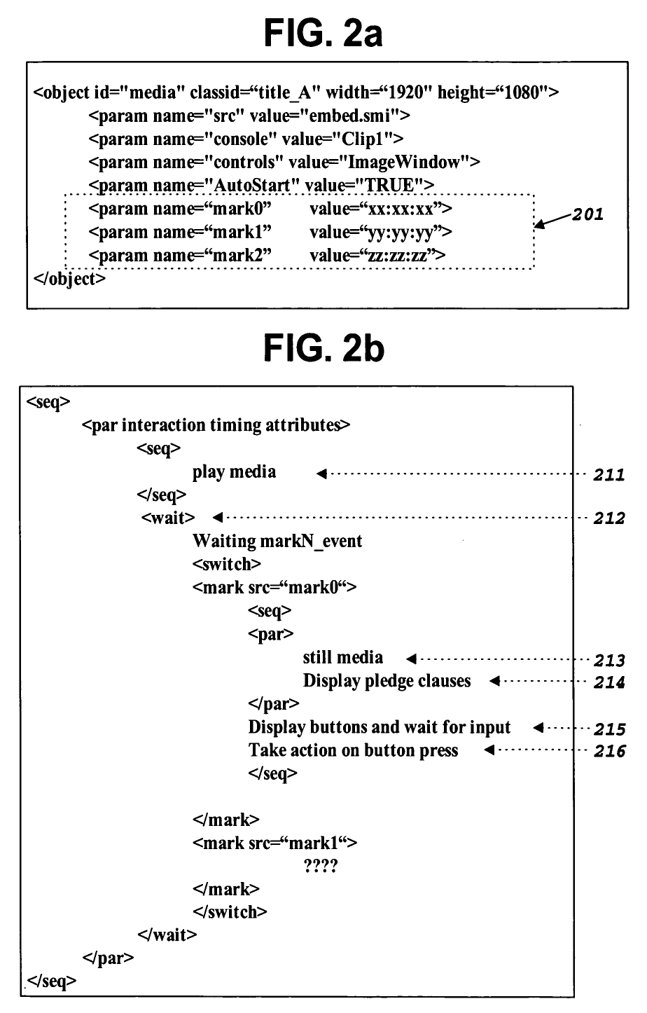

The disc 1 loaded into the apparatus of FIG. 1 contains navigation data files which are essential for the playback and/or exploration of A/V contents recorded therein. Also recorded in the disc 1 are additional navigation data which includes programming parts as shown in FIGS. 2a and 2b; the additional navigation data (which are composed of one or more than one file) are stored in the storage 20 by the disc manager 10 and interpreted by the advanced content processor 110. The storage 20 can also store additional object data such as small-sized scenes, sound effects, and so on which make up the additional navigation data, whereas the data cache 21 stores temporary objects which become obsolete after a single use.

The programming parts shown in FIGS. 2a and 2b have been introduced only as examples to illustrate setting positions or intervals of content according to the present invention; therefore, the scope and intention of the present invention are not constrained by the examples of FIGS. 2a and 2b. Besides, the additional navigation data including the programming parts as shown in FIGS. 2a and 2b can be received from an external network other than the loaded disc 1 by the network manager 11 and stored into the storage 20 and the data cache 21 (additional objects).

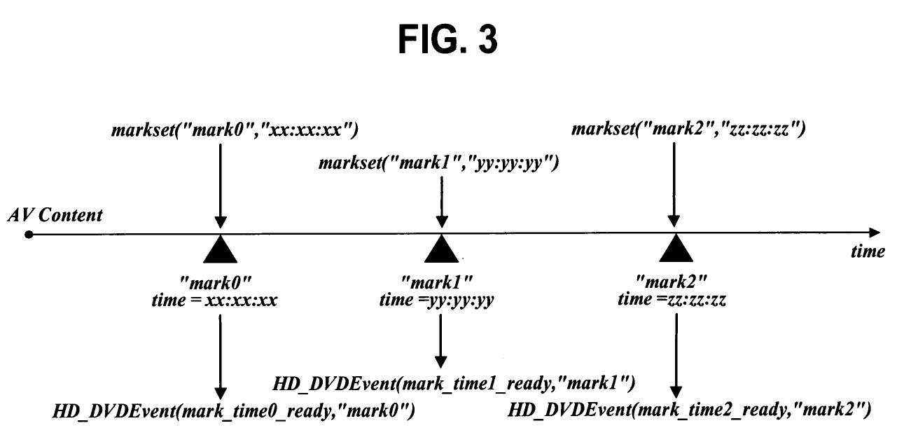

As shown in FIG. 3, additional navigation data according to the present invention have mark information for setting particular positions of A/V content recorded in the disc 1. The marks shown in FIG. 3 (mark0, mark1, mark2) follow the mark definitions 201 of FIG. 2a written in XML for an illustrative purpose.

The advanced content processor 110 interprets a start-up script file from among the additional navigation data which are stored in the storage 20, whereby a data definition file, a part of which is illustrated in FIG. 2a, and data operation file, a part of which is illustrated in FIG. 2b, both playing as loading sources, are read and interpreted respectively.

First, according to the mark definition information of FIG. 2a, the advanced content processor 110 delivers three mark setting commands to the playback controller 100. At this moment, the command about a mark can be delivered in the form of API (Application Program Interface), which is delivered, for example, as the string of “MarkSet (markN, marktime)” (where markN is a name holder to identify each mark and denoted illustratively by “mark0”, “mark1”, and “mark2”; and marktime corresponds to presentation time denoted by xx:xx:xx, yy:yy:yy, and zz:zz:zz).

The playback controller 100, which has received the mark setting commands, interprets the commands as specified, delivers the time of each mark to the playback manager 40 and sets up to provide a notification signal when the presentation time of A/V data being reproduced becomes the delivered time; accordingly, each input mark time is set up in the playback manager 40.

The advanced content processor 110 interprets the operation data file and based on a first command “play media” 211 specified therein, issues a playback request to the playback controller 100; accordingly, the A/V contents in the disc 1, under the control of the playback controller 100, are fed sequentially into the main decoder 32, thereby decoded and reproduced as video and audio signals. A/V data packet being decoded during this period, for example, the presentation time of a PES packet, is delivered to the playback manager 40.

When any one from among the designated mark time, for example, the presentation time which is the same as the mark time of mark1 is input during the playback period, the playback manager 40 delivers the time to the playback controller 100; the playback controller 100 notifies the detection of the particular mark position by transmitting the mark information corresponding to the time to the advanced content processor 110 according to the specified API definition, for example, in the form of a reply such as “HD_DVDEvent (mark_time_ready, markN)”. In this example, mark_time_ready can either the time set previously for markN, or the presentation time delivered from the playback manager 40.

On the one hand, according to the execution of the operation data file, after having requested media playback, the advanced content processor 110, which was waiting for the occurrence event of a mark as instructed by the <wait> tag 212, carries out operations specified differently according to respective marks upon reception of the occurrence event of a mark. For instance, when the received mark corresponds to mark0, the content associated with the tag <mark src=mark0> are carried out: First, by the command “still media” 213, an API command to stop playing media is delivered to the playback controller 100 which then orders the playback manager 40 to stop the presentation of A/V content. Thereafter, the playback manager 40 stops decoding of the main decoder 32. Since the read data are not reproduced in the disc manager 10 (because overflow is occurred in the internal buffer) when the decoded output of the main decoder 32 is stopped, the disc manager 10 automatically pauses the playback position of the disc 1.

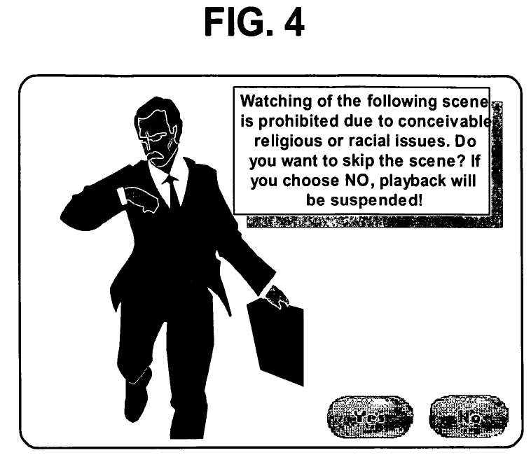

Subsequently, the advanced content processor 110 sequentially carries out the operations specified for mark0 in the operation data file. For example, the advanced content processor 110 displays guiding instructions 214, composes buttons for receiving user inputs and displays in the form as FIG. 4 shows 215, and carries out the operations according to the button selected by the user 216. These operations are realized by the cooperation of the playback controller 100 and the advanced presentation engine 30 and user inputs are dealt with the input device 12. If the received mark is a different one other than mark0, operations specified for the mark are carried out.

When the received mark is mark1 and the operation specified for the mark corresponds to playback skip up to mark2, the advanced content processor 110, by using API commands, requests the playback controller 100 to jump to zz:zz:zz which corresponds to the time for mark2. Accordingly, the playback controller 100 controls the disc manager 10 and playback manager 40 so that the playback position is moved to where the presentation time equals to zz:zz:zz, whereby the particular interval designated by the additional navigation data, namely, the A/V interval designated from mark1 to mark2 can be skipped.

In another embodiment of the present invention, instead of using presentation time, a navigation unit at the corresponding position of the recorded A/V data, namely, the number of VOBU (Video Object Unit) can be used as a variable to denote the position of the mark.

Also, the mark according to the present invention can be used differently to indicate the information about the interval to be reproduced. For instance, if the information of each mark is recorded in the additional navigation data with respect to the start position of each chapter of the contents recorded in the disc 1, the marks corresponding to respective chapters are set individually by the advanced content processor 110 at the playback controller 100, and presentation time information which provides the position information about the corresponding points is delivered to the playback manager 40.

According to the settings above, after the playback of the content, when the corresponding playback position (the start position of a chapter) has been reached, a notification is arrived from the playback manager 40, whereby the playback controller 100 recognizes that the chapter has been changed. In other words, the playback information of the content being reproduced can be displayed at a display unit such as an LCD panel (not shown); for example, by incrementing the chapter index by one (in the case of forward direction playback), the user can be informed that the chapter to be reproduced has been changed.

Also, by obtaining the presentation time from the playback manager 40 and subtracting the time information of the mark set for the chapter, progression time within the chapter of the content currently being reproduced can be displayed.

With the marks set for respective chapters in said manner, a search operation for a chapter can also be carried out in such a way that the advanced content processor 110 requests the playback controller 100 a movement between the marks.

The marks set in said manner can be removed either by the user request, or by the written commands of additional navigation data. For the removal of the marks, an API command which is delivered from the advanced content processor 110 to the playback controller 100 can have the form of “Un-markSet (markN)”. When the command as above is received, the playback controller 100 delivers the time set for “markN” to the playback manager 40 in order for the time to be erased. If the received “markN” is a string not belonging to the set of marks designated before, for example, when the string is “0”, the playback controller 100 may ignore the mark removal command or remove all the marks set previously.

According to at least one embodiment of the present invention as described in detail hereinbefore, by setting marks, particular intervals of content can be reproduced according to a predetermined scenario; besides, such a particular playback method can be freely set/modified by additional navigation data.

Also, instead of providing information continuously to playback control resources, since events are notified only where the marks have been set, the system load for the playback of a disc player is reduced.

The present invention is not limited to the foregoing description of preferred embodiments and those skilled in the art will easily appreciate that numerous embodiments with improvements, modifications, substitutions, or additions can be realized within the spirit and scope of the present invention. It is intended that all such improvements, modifications, substitutions, or additions fall within the spirit and scope of the invention as defined by the following appended claims.

What is claimed is:

1. A recording medium including content and additional navigation data for interactive playback of the content recorded thereon,
wherein the additional navigation data is incorporated in at least one file, and contains at least one mark information indicating a position within the content, and a command specifying operations to be performed on detection of a position corresponding to the mark information during playback of the content, and
wherein the mark information includes position information of a corresponding point and identification information of a mark.

2. The recording medium of claim 1, wherein the identification information of a mark is string information about mark name.

3. The recording medium of claim 1, wherein the position information is expressed in terms of presentation time.

4. The recording medium of claim 1, wherein the position information is expressed in terms of number of a navigation unit, the navigation unit being a unit to partition the content.

5. A method for reproducing content recorded on a recording medium, comprising:
(a) obtaining additional navigation data for interactive playback of the content;
(b) setting a position within the content corresponding to each mark information to a playback engine, which reproduces and decodes the content, based on one or more mark information contained in the obtained additional navigation data; and
(c) performing an operation specified in the additional navigation data with respect to mark information associated with a detected position if detection of a position is notified from the playback engine in the course of playback of the content.

6. The method of claim 5, wherein the mark information includes position information of a corresponding point and identification information of a mark.

7. The method of claim 5, wherein said step (a) obtains the additional navigation data from the recording medium.

8. The method of claim 5, wherein said step (a) obtains the additional navigation data from a remote server through a communication network.

9. The method of claim 5, wherein the specified operation with respect to mark information includes operations to pause the content being reproduced by the playback engine and to wait for a user input.

10. A method for reproducing content recorded on a recording medium, comprising:
(a) obtaining additional navigation data for interactive playback of the content;
(b) setting a position within the content corresponding to each mark information to a playback engine, which reproduces and decodes the content, based on one or more mark information contained in the obtained additional navigation data; and
(c) changing displayed playback information of the content, if detection of a position is notified from the playback engine in the course of playback of the content.

11. An apparatus for reproducing content recorded on a recording medium, comprising:
a playback unit for reading the recorded content by driving the recording medium and for decoding the read content; and
a processor interpreting additional navigation data for interactive playback of the content,
wherein the processor sets a position within the content to the playback unit based on one or more mark information contained in the additional navigation data, and performs an operation specified by the navigation data with respect to mark information associated with a detected position if detection of the set position is notified from the playback unit.

12. The apparatus of claim 11, wherein the mark information includes position information of a corresponding point and identification information of a mark, and the processor sets a position within the content corresponding to mark information by delivering a mark setting command including the position information and identification information to the playback unit.

13. The apparatus of claim 11, wherein the playback unit notifies detection of the set position by delivering event information including mark identification information associated with the detected position to the processor, when the set position is detected in the course of reproducing the content.

14. The apparatus of claim 11, wherein the advanced navigation data is obtained from the recording medium.

15. The apparatus of claim 11, wherein the additional navigation data is obtained from a remote server through a network interface connected to a communication network.

16. The apparatus of claim 11, wherein the processor, with help of the playback unit, performs the operation specified with respect to mark information associated with the detected position.

17. The apparatus of claim 16, wherein the specified operation with respect to mark information include operations to pause the content being reproduced by the playback unit and to wait for a user input.

18. The apparatus of claim 11, wherein the processor requests removal of the set position to the playback unit, according to a user input or a command specified by the advanced navigation data.

19. The apparatus for reproducing content recorded on a recording medium, comprising:
a control unit controlling a playback unit which reads the recorded content by driving the recording-medium and decodes the read content; and
a processor interpreting additional navigation data for interactive playback of the content and setting a position within the content to the playback unit according to each mark information, based on one or more mark information contained in the additional navigation data,
wherein the control unit changes displayed playback information of the content during playback of the content when detection of the set position is notified from the playback unit.
